(19) United States
(12) Patent Application Publication
(10) Pub. No.: US 2010/0106280 A1
(43) Pub. Date: Apr. 29, 2010

(54) Method and an apparatus for identifying variable and common module variants in a product family and managing resulting variants

(75) Inventors: Thorbjorn Hansen, Munich (DE); Christian Staner, Marquartstein (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 12/453,886

(22) Filed: May 26, 2009

(30) Foreign Application Priority Data
Oct. 29, 2008 (EP) EP08018902

(51) Int. Cl. G06Q 10/00; G06F 17/00; G06N 5/02

(52) U.S. Cl. 700/107; 705/7; 706/46

(57) ABSTRACT

A method and an apparatus reduce the complexity of the design of product platforms, of the design of product lines and of variant management. A product is broken down into systems, which are subdivided into modules. In any given product, each module is realized by one concrete module variant out of a set of possible module variants, where unwanted combinations are avoided. Packaging is supported across one or more systems. Variant management manages the set of all variants as a whole. The introduced method and the apparatus holds the advantage, that products, which comprise common module variants and variable module variants, can be designed more efficiently.

### CROSS REFERENCE TO RELATED APPLICATIONS

This application is based on and hereby claims priority to European Application No. EP08018902 filed on Oct. 29, 2008, the contents of which are hereby incorporated by reference.

### BACKGROUND OF THE INVENTION

In several market segments not only a single product but several variants of the product, so called product families or product lines, are required for satisfying customer needs. This raises costs for research and development of the product families compared to the development of a single product. Developing a product portfolio typically results in high research efforts, development costs and a long time to market.

Product portfolios typically comprise products, which are mainly constructed in the same way but differ in a certain number of parts, being tailored to specific customer needs. Hence, several variants of the same product need to be developed according to a specific requirement description. Variant management is not only required in terms of mass customization but also for reducing costs through standardization of module variants. Accordingly often product families are developed, which strive to hold a maximum of common module variants so that adaptations to specific customer requirements can be accomplished based on a minimum of specific, not common module variants.

Since designing individual products for each customer's requirements may be slow and expensive, several product variants can be designed together in a product line, also referred to as product family. Designing a product family is usually more difficult than designing an individual product. Therefore, one must balance increased costs arising from the need for customization by lowering costs by standardization. Standardization can be accomplished by designing a platform including a set of common module variants, which may be extended by interchangeable module variants.

Commonly known methods apply techniques based on requirements analysis. Requirements analysis represents a basic step in the design of product lines.

Other commonly known methods apply a simulation of virtual products, which can be customized by interchanging predefined module variants from a module variant library.

The complex task of product platform design, product line design and variant management requires a methodology for supporting the design process of the whole product family. A system centric approach needs to be applied in mechatronics related product management processes for portfolio optimization and cost reductions and to increase effectiveness of the product management.

### SUMMARY

It is therefore one possible object to provide a method and an apparatus for identifying variable and common module variants in a product family and managing resulting variants, the so called module variant combinations.

The inventors propose a method for identifying variable and common module variants in a product family and managing resulting variants, wherein a system provides a system functionality by a co-operation of at least one module variant, the method comprising the steps of:
decomposing a product into systems and specifying the system functionality;
subdividing the specified system functionality into at least one module functionality;
identifying at least one module variant for each of the at least one module functionality, the module variant providing the specified module functionality;
managing the resulting variants, which comprises calculating parameters as a function of the resulting variants; and
arranging the at least one identified module variant according to at least one provided arrangement parameter in at least one system.

The set of all variants of a system can be described by a group of parameters, such as a plurality of module variants, a selection of module variants or an arrangement specification of module variants. The system may be comprised in a product. A product may furthermore comprise several systems. Several module variants may be comprised in a system variant.

At least a selection of the aforementioned steps can be performed iteratively and/or in a different order.

In possible embodiment the product is a train, comprising a brake system.

The train can be arranged to drive along rails, for which a plurality of systems is required. For instance a drive system, wheels and a brake system may be required. Each system can comprise a plurality of module variants, which provide the system functionality if the module variants co-operate properly. The brake system can for instance comprise at least one brake disk.

In a possible embodiment the system comprises a plurality of modules, or subsystems. Hence, a product, such as a train can be modeled at a configurable granularity.

According to an aspect of the method, a system view, which models for instance a product, can be generated at a configurable level of detail.

It may be of advantage to generate different views of a product for scaling the complexity and handling several variants of a product. For instance, one system view can be generated, describing the system “wagon”, comprising the module “wagon body shell”.

It may be of advantage, to consider only common module variants of a product family, for the generation of the system view. A product family can comprise common module variants, which are constructed in the same way for each product of the product family. A product may comprise further individual module variants, which are designed for special variants of the product. Hence, a holistic system centric modeling approach, considering both common, as well as special module variants, can be applied in the development field of mechatronics, according to an aspect.

Decomposing the product into systems and specifying the system functionality can be performed by requirements engineering. For determining a required system functionality a requirements tree or a requirement model can be created. The requirement model may describe the customers' requirements regarding the product. A requirement may for instance be a wagon length, a plurality of windows per wagon or a window width. According to an aspect of the proposal, the requirements tree and the requirement model do not necessarily consider concrete module variants. A concrete module variant may be an individual module variant, which is only required for specific variants. Such concrete module variants may be modeled in a solution model and/or in a solution tree.

The requirements tree and/or the requirements model may become extensive during the modeling process. Therefore, the requirement model and/or the requirements tree may be partitioned into several models and/or trees. These models and/or these trees are not necessarily disjoint, but may also overlap. For example, it may be of advantage to separate the requirements concerning the wagons dimensions and the requirements concerning windows.

The solution model and/or the solution tree may comprise solutions, which are combinations of the identified module variants. Solutions may fulfill the premodeled requirements, and may furthermore hold a plurality of further parameters. Such further parameters may for instance be a market price of the module variants. It may be of advantage according to an aspect of the proposal to identify the cheapest combination of module variants fulfilling a certain requirement.

The identified module variants can be arranged according to at least one provided arrangement parameter. For instance, a machine has to fit into a specific casing. Therefore, the machine must not exceed the measurement or dimension of the case. It may appear, that a combination of module variants satisfying requirements does not fit into the case. In this situation an alternative combination must be chosen, which responds to at least one provided arrangement parameter. The arrangement parameter may be defined by the measurements of the case.

For creating an arrangement specification and/or for providing the arrangement parameter a CAD program may be applied. The abbreviation CAD stands for Computer Aided Design. In a possible embodiment the CAD program has access to a library comprising module variants. These module variants can be selected and virtually arranged, thus simulating the arrangement of the system.

It may be of advantage to identify a minimal number of combinations of module variants. This results in a reduced complexity of the product family, as a standardization and usage of mainly common module variants, is reached.

The inventors furthermore propose a method for identifying variable and common module variants in a product the method comprising:
decomposing the product into systems each providing a system functionality by a co-operation of the module variants and specifying each system functionality;
subdividing each specified system functionality into at least one module functionality; and
identifying at least one module variant for each of the at least one module functionality, the module variant providing the specified module functionality.

According to another aspect of the proposal managing the resulting variants is accomplished, which comprises calculating parameters as a function of the variants.

Furthermore, arranging the at least one identified module variant according to at least one provided arrangement parameter in at least one system of the product may be accomplished.

The inventors also propose a method for identifying at least one dependency between a system and at least one module variant of the system, wherein the system provides a system functionality by a co-operation of the at least one module variant, the method comprises:
specifying the system functionality;
subdividing the specified system functionality into at least one module functionality;
identifying at least one module variant for each of the at least one module functionality, the module variant providing the specified module functionality; and
arranging the at least one identified module variant according to at least one provided arrangement parameter for providing the system.

The inventors furthermore propose a method for determining a bill of materials, also referred to as BOMs, of a product, the product comprising at least one module variant, wherein the product provides a product functionality by a co-operation of the at least one module variant, the method comprising:
decomposing the product into systems and specifying the product functionality;
subdividing the specified product functionality into at least one module functionality;
identifying at least one module variant for each of the at least one module functionality, the module variant providing the specified module functionality;
managing the resulting variants, which comprises calculating parameters as a function of the resulting variants;
assembling the at least one identified module variant according to at least one provided assembling parameter in at least one system;
generating the bill of materials for one product and calculating parameters listed in it; and
calculating parameters based on the bill of materials of several product variants of a product family.

The resulting variants may also be referred to as “module variant combinations”.

A BOM comprises several module variants, used for provision of the system. The BOM lists in a possible embodiment parameters of the module variants. Such parameters are for instance a price, a delivery duration and/or operating parameters of the module variants. Parameters based on the BOMs of several product variants of a product family are for instance the material costs, which can depend on the number of parts ordered for all products variants in the product family.

At least a selection of the aforementioned steps may be performed iteratively and/or in a different order. Hence, several BOMs are created, which describe several variants of the product, and parameters based on several BOMS are calculated. This has the advantage that several options can be iteratively simulated. Furthermore, an assessment of a first accomplishment of the steps is possible.

The inventors furthermore propose an apparatus for identification of variable and common module variants in a product family and management of resulting variants, wherein a system provides a system functionality by a co-operation of at least one module variant, the apparatus comprising:
a functionality specification unit for decomposing the product into systems and specifying the system functionality;
a system functionality subdividing unit for subdividing the specified system functionality into at least one module functionality;
a module variant identification unit for identifying at least one module variant for each of the at least one module functionality, the module variant providing the specified module functionality;
a variant management unit for managing the resulting variants, which comprises a calculation of parameters as a function of the resulting variants; and
a module variant arrangement unit for arranging the at least one identified module variant according to at least one provided arrangement parameter in at least one system.

The apparatus operates according to at least one of the aforementioned methods. The functionality specification unit, the system functionality subdividing unit, the module variant identification unit, the variant management unit and/or the module variant arrangement unit are formed by separate calculation unit or one single calculation unit.

The inventors further propose a computer for identification of variable and common module variants in a product family and management of the resulting variants, also referred to as module variant combinations, wherein the system provides a system functionality by a co-operation of at least one module variant, the computer comprising:
a functionality specification unit for decomposing a product into systems and specifying the system functionality;
a system functionality subdividing unit for subdividing the specified system functionality into at least one module functionality;
a module variant identification unit for identifying at least one module variant for each of the at least one module functionality, the module variant providing the specified module functionality;
a variant management unit for managing the resulting variants, which comprises calculating parameters as a function of the resulting variants; and
a module variant arrangement unit for arranging the at least one identified module variant according to at least one provided arrangement parameter in at least one system.

The computer operates according to at least one of the aforementioned methods. The functionality specification unit, the system functionality subdividing unit, the module variant identification unit, the variant management unit and/or the module variant arrangement unit are formed by separate calculation units or by one single calculation unit.

The calculation unit can be formed by a processor, a micro processor, a computer, a computer system, a central processing unit, an arithmetic calculation unit and/or a hardwired circuit.

For operating the computer further storage unit can be provided, such as a hard disc, a hard drive, a USB stick, a floppy disc, a disc, a CD, a DVD, a Bluray disc, a magnetic tape and/or a removable storage medium. The computer may furthermore communicate with a further computer, for instance a database server. This communication can be performed over a network. Such a network can comprise a router, a server, a client, a network card, a receiver, a sender, an antenna, a modem, a cable, a switch, a hub, and/or further network related devices.

The inventors furthermore propose an apparatus for determination of a bill of materials, also referred to as BOM, of a product, the product comprising at least one module variant, wherein the product provides a product functionality by a co-operation of the at least one module variant, the apparatus comprising:
a product functionality specification unit for decomposing the product into systems and specifying the product functionality;
a product functionality subdividing unit for subdividing the specified product functionality into at least one module functionality;
a module variant identification unit for identifying at least one module variant for each of the at least one module functionality, the module variant providing the specified module functionality;
a variant management unit for managing the resulting variants, which comprises calculating parameters as a function of the resulting variants; and
a module variant assembling unit for assembling the at least one identified module variant according to at least one provided assembling parameter in at least one system.

The apparatus may operate according to at least one of the aforementioned methods. The product functionality specification unit, the product functionality subdividing unit, the module variant identification unit and/or the module variant assembling unit may be formed by separate calculation unit or by one single calculation unit.

A computer program is adapted to perform an execution of at least one of the aforementioned methods.

A data carrier stores a computer program according to at least one of the aforementioned methods.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a flow diagram of a method for identifying variable and common module variants in a product family and managing the resulting variants module variant combinations, according to an aspect of the proposal;

FIG. 2 shows a detailed flow diagram of a method for identifying variable and common module variants in a product family and managing the resulting variants, module variant combinations, according to an aspect of the proposal;

FIG. 3 shows a block diagram of an apparatus for identification of variable and common module variants in a product family and management of the resulting variants, module variant combinations, according to an aspect of the proposal;

FIG. 4 shows a detailed block diagram of an apparatus for identification of variable and common module variants in a product family and management of the resulting variants, module variant combinations, according to an aspect of the proposal;

FIG. 5 shows a flow diagram of a method for determining a bill of materials of a product and calculating parameters as a function of the bill of materials of several product variants of a product family according to an aspect of the proposal;

FIG. 6 shows a detailed flow diagram of a method for determining a bill of materials of a product and calculating parameters based on the bill of materials of several product variants of a product family according to an aspect of the proposal;

FIG. 7 shows a requirements tree according to an aspect of the proposal;

FIG. 8 shows a requirements tree according to an aspect of the proposal;

FIG. 9 shows a solution tree according to an aspect of the proposal; and

FIG. 10 shows a solution tree according to an aspect of the proposal.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

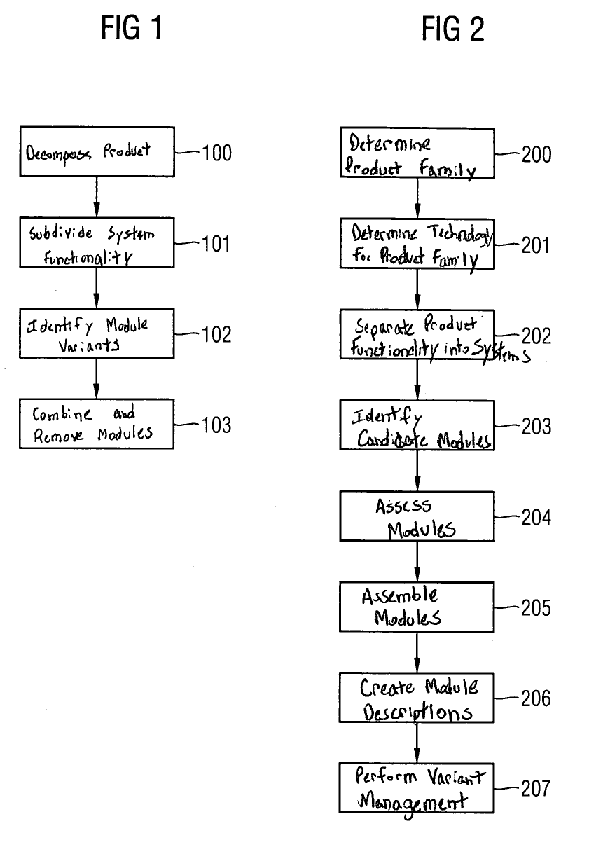

FIG. 1 shows a flow diagram of a method for identifying variable and common module variants in a product family and managing the resulting variants, module variant combinations, comprising the following steps:

In a first step 100 the product is decomposed into systems and the system functionality of each system is specified. In a subsequent step 101 the specified system functionality is subdivided into at least one module functionality. In a further step 102 at least one module variant for each of the at least one module functionality is identified, the module variant providing the specified module functionality. In a further step 103 the resulting variants, module variant combinations, are established and unwanted variants are removed. In a subsequent step 104 the at least one identified module variant is arranged according to at least one provided arrangement parameter in one or more systems.

FIG. 2 shows a detailed flow diagram of a method for identifying variable and common module variants in a product family and managing the resulting variants, module variant combinations, comprising the following steps:

In a first step 200 the product family, which has to be developed is determined. This step may comprise a market segmentation as a function of predefined parameters, which can e.g. define that a product family of trains can be described by a performance of a train and/or a capacity of a train. Hence, different market segments are identified. Step 200 may be performed by analysis of provided project documentations, which describe the product family and respective parameters or by analysis of provided tables or diagrams, describing the product family.

In a subsequent step 201 a technology, which is applied for constructing the product family, is determined. The applied technology can be provided by specifications of module variants, modules and/or systems, which were applied in former product family design processes. A database describing available technology can be provided, which describes operating parameters, such as an interface of available systems.

In a subsequent step 202 the functionality of the product family, which has to be developed, is broken down into systems. A system is a part of a product. A system can for instance be a wagon, a brake system or a drive. It may hence be identified, that a train comprises several systems, such as a wagon, a brake system and a drive.

The step 202 can comprise further substeps such as the development of a requirements tree and/or a requirements model. The requirements tree and/or the requirements model may also be developed in the step 200 and/or the step 201. The requirements tree and/or the requirements model may describe requirements, which are to be fulfilled by the product family to be developed. In step 202 a combination of requirements can be defined. Each of the combinations of requirements describes the overall requirements of one variant of a product of the product family. Such a combination of requirements can be modeled by a path of the requirements tree. The requirements tree can for example model, that in one variant of the train a certain capacity and/or a certain performance is required. In a possible embodiment several requirements trees are defined in step 202.

The systems as defined in step 202 form the product, or at least a part of the product. Each system can comprise several subsystems, modules, module variants or any further partition of the product to be developed. The system is defined by its functionality.

In step 203 at least one module candidate is identified. A module candidate provides at least a part of a system, as identified in step 202. Module candidates are provisional proposals for modules, when they pass the module assessment in step 204, they turn into modules. Each module, and accordingly also each module candidate, can comprise physical module variants and/or at least one instruction for an action. A module may for instance define control commands of a machine, calculation steps and/or source code of a computer program product. The module candidates identified in step 203 can comprise at least one further module, system and/or module variant. Each of the modules identified in step 203 can form at least a part of one of the systems identified in step 202.

The step 203 of identifying at least one module candidate can comprise further substeps. The module identification, as performed in step 203, comprises in a possible embodiment the development of a solution model and/or a solution tree. Each path in a solution tree defines a desired combination of module variants, which satisfy at least one requirement towards the product. Thus the solution tree contains all desired combinations of module variants. The solution tree can be developed by analysis of module variant descriptions, and comparing at least a part of the module variant description with at least a part of the requirements tree. In a requirements tree a certain capacity of the train may be demanded. For example in step 203 a requirement “capacity” is compared to module variant specifications, and furthermore a set of module variants may be identified, which provide that demanded capacity.

In step 203 common module candidates are identified, whose module variants are applied in several products, as well as not common module candidates, whose module variants vary and form a variant of the product. It may be of advantage to identify a maximum of common modules which can be applied in the construction of each of the products being comprised in the product family. Hence, a standardization can be reached, which increases efficiency of the construction process and furthermore decreases time to market and/or development costs. It is also of advantage, to identify a minimum of module variant combinations, which still fulfill the requirements. This results in a minimum number of variants, which satisfy the requirements of several customers.

In step 203, unwanted variants, module variant combinations, may be excluded.

In step 204 a module assessment is accomplished. In a module assessment at least one of the module candidates identified in step 203 is evaluated. If it passes the assessment, it is considered a module. Otherwise it is discarded or modified until it passes the assessment. The step 204 can comprise several substeps, such as an adaptation of at least one module identified in step 203. In step 204 at least one module candidate is assessed and either promoted to module or changed, for instance by adding module variants, removing module variants or excluding unwanted variants (module variant combinations).

In step 204, unwanted variants, module variant combinations, may be excluded.

In a possible embodiment step 203 and step 204 are performed iteratively. Hence, several module candidates, their module variants and their combinations are identified and refined in step 203 and/or in step 204. A module assessment may also be accomplished by comparing a required feature of the module with the at least one feature provided by the module variant.

In step 205 a packaging is performed. The packaging comprises an assembling of the modules, being identified in step 203. The assembly comprises the construction of a subset of the product by joining module variants which may belong to one or several different systems. A first module variant can include a second module variant. In step 205 arrangement parameters are determined as a function of the first module variant. The first module variant is for instance a case, which is arranged to enclose several other module variants. The arrangement parameters are determined as a function of the measurement of the case and the enclosed module variants. During the accomplishment of the packaging it may be recognized, that at least one of the module variants identified in step 203 do not fulfill the required measurements. Accordingly, step 203 can be performed again, under consideration of the required measurements. It may also be detected in step 204, that the module variant identified in step 203 does not fulfill a specified arrangement parameter.

The packaging is performed in a possible embodiment by assembling the physical sub-module variants being comprised in at least one module variant. The packaging can be performed under usage of a Computer Aided Design program, also referred to as CAD program. In step 205 each of the module variants identified in step 203 are simulated. A simulation of at least one module variant can also be performed in step 204 during the module assessment process.

A CAD program has in a possible embodiment access to database providing the measurements and/or arrangement parameters of each of the module variants. The database provides information on how the module variants are assembled. In step 205 an arrangement specification is provided. The arrangement specification can describe how the module variants are assembled. The arrangement specification can describe several possibilities to arrange the module variants. In a possible embodiment for each module and/or each module variant at least one arrangement specification is developed. The arrangement specification can comprise textual content and/or graphical content.

In step 206 module descriptions are created. A module description comprises the modules, together with the module variants of each module. A module description can be formed by a first table, which describes the characteristics of the module that are common to all module variants, and a second table, which describes the characteristics of the non common module variants. Characteristics include the number of module variants, an identification code of a module variant, an operation parameter of a module variant and/or further parameters describing features of the module variants. The module description can comprise textual content and/or graphical content, such as a visualization of at least one module.

In step 207 a variant management is performed. Unwanted combinations of module variants may be excluded. The remaining wanted combinations of module variants are defined as product variants. In step 206 information is provided, which allows for comparing variants of products, systems and modules. Based on the information provided in step 206, for instance, the cheapest solution can be identified in step 207. In a possible embodiment a variant is identified, which has the lowest delivery time, compared to other variants.

In an embodiment of the proposal at least one of the aforementioned steps is performed iteratively and/or in a different order.

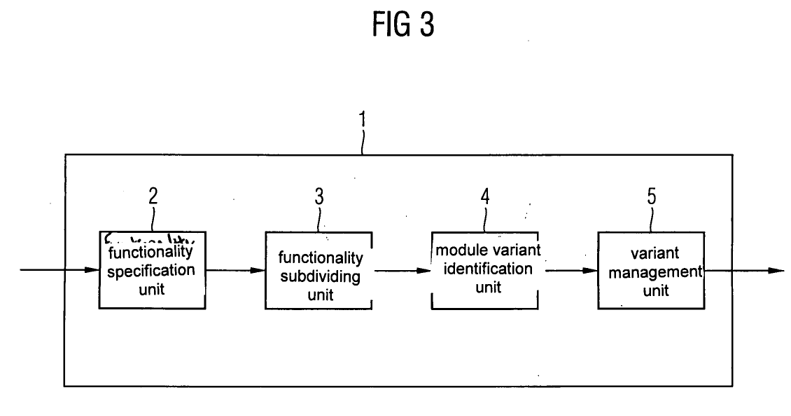

FIG. 3 shows a block diagram of an apparatus 1 to identify variable and common module variants in a product family and manage the resulting variants, module variant combinations, according to an aspect of the proposal. The apparatus 1 comprises a functionality specification unit 2 for decomposing the product into systems and specifying the system functionality of a system. The apparatus 1 further comprises a system functionality subdividing unit 3 for subdividing the specified system functionality into at least one module functionality. The apparatus 1 further comprises a module variant identification unit 4 for identifying at least one module variant for each of the at least one module functionality, wherein the respective module variant provides the specified module functionality. The apparatus 1 further comprises a variant management unit 5 to manage the resulting variants, module variant combinations, and compute parameters depending on the combinations. The apparatus 1 further comprises a module variant arrangement unit 6 for arranging the at least one identified module variant according to at least one provided arrangement parameter in one or more systems.

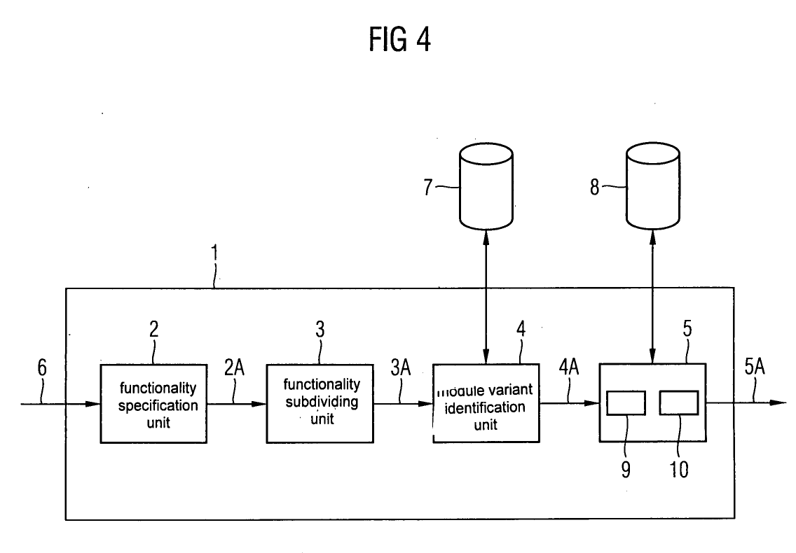

FIG. 4 shows a detailed block diagram of an apparatus 1 to identify variable and common module variants in a product family and manage the resulting variants, module variant combinations, according to an aspect of the proposal and differs from the apparatus 1 as shown in FIG. 3 as follows:
The apparatus 1 comprises a functionality specification unit 2, which receives requirements 6 regarding a product. The functionality specification unit 2 is arranged to analyze the requirements 6 and is further arranged to specify a system functionality 2A. The system functionality 2A fulfills the requirements 6. The system functionality 2A serves as input for a system functionality subdividing unit 3. The system functionality subdividing unit 3 is arranged to identify modules, being comprised by the system. The module functionality 3A serves as input for a module variant identification unit 4.

In the present embodiment the module variant identification unit 4 communicates with a memory device 7. In the memory device 7 descriptions of module variants and available module variant combinations are stored. The memory device 7 may comprise a database, storing available module variants together with a formal description of the module variants. The description may comprise operation parameters of each of the module variants. The module variant identification unit 4 is arranged to identify module variants which provide the module functionality 3A and where the combination of module variants is one of the available module variant combinations. If no exact available module variant is found, the module variant identification unit 4 optionally provides a list of the closest matching module variants.

The module variant identification unit 4 identifies a selection of module variants 4A for each of the modules. The selection of module variants 4A serves as input for the module variant arrangement unit 5. The module variant arrangement unit 5 comprises a module packaging unit 9 and a module description unit 10.

In an embodiment the module packaging unit 9 is implemented by a CAD program. The CAD program communicates with a memory device 8. The memory device 8 comprises arrangement parameters, according to which the arrangement of the module variants is accomplished. In a possible embodiment the arrangement parameters are identified automatically, for instance by a respectively arranged sensor. Once the product is assembled, the module description unit 10 generates a module description. The generated module description can comprise several module variants. The apparatus 1 may comprise a further unit, which is arranged to accomplish variant management, for instance on the basis of the module description provided by the module description unit 10. The apparatus 1 delivers the required output 5A, which may comprise an arrangement specification and/or a module description.

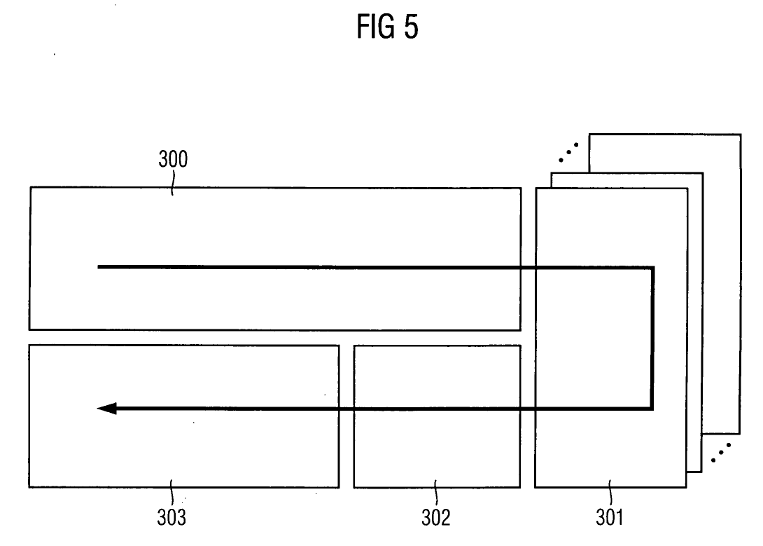

FIG. 5 shows a flow diagram of a method for determining a bill of materials of a product and calculating parameters based on the BOMs of several product variants of a product family, according to an aspect of the proposal.

In an additional substep of step 206 the system structure is used to generate a bill of materials and compute parameters listed in it.

In a further substep of step 207, parameters based on the BOMs of several product variants of a product family are calculated.

In an embodiment of the proposal at least one of the aforementioned steps is performed iteratively and/or in a different order.

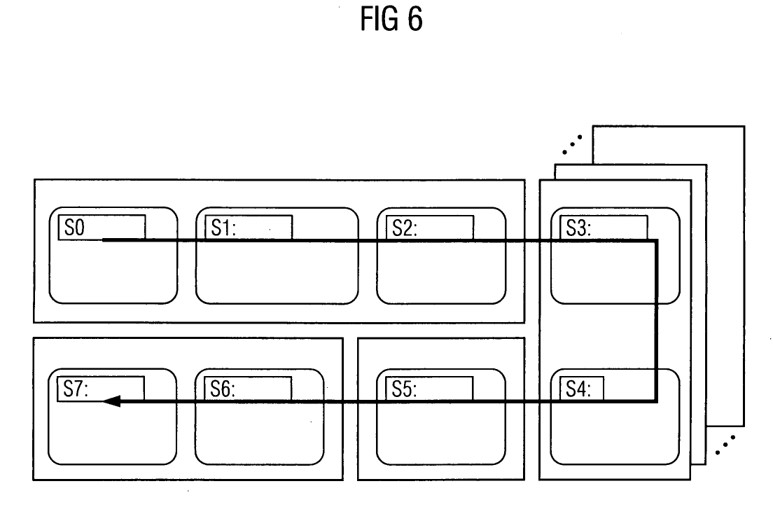

FIG. 6 shows a detailed flow diagram of a method for determining a bill of materials of a product and calculating parameters based on the BOMs of several product variants of a product family, according to an aspect of the proposal.

In a first step S0 a segmentation such as a market segmentation is provided. A market segmentation may also be referred to as product segmentation. For example, a segmentation of a train product line is determined by parameters, such as performance and capacity. Another example for a segmentation is by train types. Train types may comprise urban, interurban, long distance, high velocity parameters as well as groups of countries. There may by further criteria that are to be considered, for example a type of traction and power.

In a further step S1 the requirements are collected for the relevant segments.

In a further step S2 the system structure is defined and furthermore the systems are identified. For example, the systems “wagon” and “brake system” may be defined in step S2.

In a further step S3 a module identification is performed. Step S3 comprises a development of a requirements model. Such a requirements model can represent requirements and respective properties, such as “wagon length” and “wagon width” and there instances. An instance of a property is e.g., that a certain wagon length is twenty meters. In case the requirements model becomes to extensive during the modeling process it can be partitioned, which may result in several possibly overlapping requirements models. These requirements models indicate module candidates.

In step S3 a solution model is generated. The solution model comprises modules and module variants. For example, a module may be “seat” with module variants, such as “seat 1”, “seat 2” or “seat 3”.

In a further step S4 a gradual module assessment is performed. For an assessment of the modules the models are annotated with attributes, such as “material cost”, “number of module variant per product”, “output per variant”, “production cost” and “sales price”. Furthermore, attributes can annotate module variants and modules with meta-data like “part number”, “link to module variant”, or “link to module variant documentation”.

In a further step S5 the module variants of the system solutions are arranged in an available package space. One package space can contain module variants from different systems, for example the package space “underfloor” may contain wiring from the systems drive and brakes, tubes from the systems air-conditioning and heating.

In a further step S6 a bill of materials is created for the product.

In a further step S7 a variant management is performed. During the accomplishment of the variant management the number of variants is optimized. This may be accomplished by a comparison between the requirements model and the determined variants. Variants that do not fulfill requirements can be deleted. In case a requirement is fulfilled by several variants, all but one variant can be deleted. If there are requirements that are not fulfilled by variants, the method can be iterated.

In an embodiment at least one of the aforementioned steps is performed. These steps may be performed iteratively and/or in a different order.

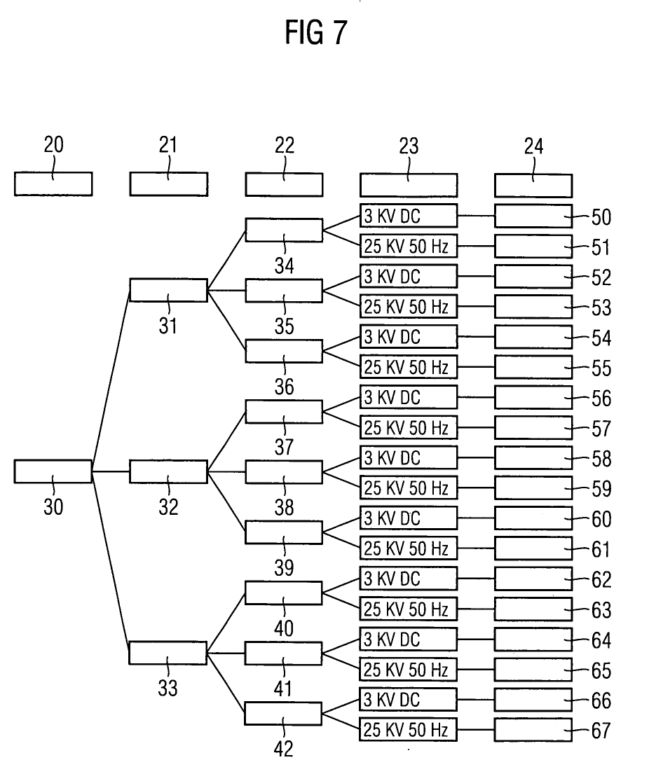

FIG. 7 shows a requirements tree according to an aspect of the proposal.

In the present exemplary embodiment a successor of the high speed train ICE is planned for the following three countries:
Spain, Switzerland and Russia.

These countries have a different rail gauge, which defines the distance between the rails. Because of the different rail gauges different axles are required. The three countries have one electrification system in common, for which two motors exist. Russia has an additional electrification system, for which a different motor is required. In the following, seven examples of products, being comprised in the product line “train family” are demonstrated.
Product Velaro E Spain, a and b
   System “Truck, bogie”
      Requirements
         rail gauge=Iberian
      Solution
         axle=A1668IB
   System “Drive”
      Requirements
         electrification system=25 kV 50 Hz
      Solution
         motor=M2550a, M2550b
Product line “Train family”
Product Velaro RUS, Russia, a and b
   System “Truck, bogie”
      Requirements
         rail gauge=Russian
      Solution
         axle=A1520RU
   System “Drive”
      Requirements
         electrification system=25 kV 50 Hz
      Solution
         motor=M2550a, M2550b
Product line “Train family”
Product CRH 3, Switzerland, a and b
   System “Truck, bogie”
      Requirements
         rail gauge=Standard
      Solution
         axle=A1435AST
   System “Drive”
      Requirements
         electrification system=25 kV 50 Hz
      Solution
         motor=M2550a, M2550b
Product line “Train family”
Velaro RUS, Russia, c
   System “Truck, bogie”
      Requirements
         rail gauge=Russian
      Solution
         axle=A1520RU
   System “Drive”
      Requirements
         electrification system=3 kV DC
      Solution
         motor=M3DC

A product line and/or a product family comprises several products that have common module variants and variable module variants. The common module variants are also referred to as a platform. A product comprises at least one system. A system can comprise subsystems, which may in turn comprise subsystems. According to an aspect of the proposal a level of detail for modeling systems is configurable. For each system corresponding requirements and solutions are defined according to an aspect of the proposal.

In the present embodiment four examples of products can be modeled by a single system structure. Such a system structure is demonstrated as follows:
Product line “Train family”
   System “all”
      Requirements
         country=Spain, Switzerland, Russia
      Solution
         Velaro=Velaro E, CRH 3, Velaro RUS
   System “Truck, bogie”
      Requirements
         rail gauge=Standard, Iberian, Russian
      Solution
         axle =A1435AST, A1668IB, A1520RU
   System “Drive”
      Requirements
         electrification system=25 kV 50 Hz, 3 kV DC
      Solution
         motor=M2550a, M2550b, M3DC

The requirements of the product line “train family” can also be modeled in a requirements tree, as shown in FIG. 7. The requirements tree holds a hierarchical decomposition of the requirements. In the present embodiment the requirements tree describes a model 30. The requirements tree is modeled according to five columns, wherein the first column 20 comprises a root node, the second column 21 holds the country, the third column 22 holds the rail gauge, the fourth column 23 holds the electrification system and the fifth column 24 holds the variants. The requirements tree as demonstrated in the present embodiment describes the following requirements:

| Reference signs | Requirements |
|---|---|
| 20 | Root |
| 21 | Country |
| 22 | Rail gauge |
| 23 | Electrification system |
| 24 | Variant |

The full tree comprising all requirements as shown in FIG. 7 comprises combinations that are not wanted. The reference signs hold the following meaning:

| Reference signs | Requirements |
|---|---|
| 30 | Model |
| 31 | Spain |
| 32 | Switzerland |
| 33 | Russia |
| 34 | Standard |
| 35 | Russian |
| 36 | Iberian |
| 37 | Standard |
| 38 | Russian |
| 39 | Iberian |
| 40 | Standard |
| 41 | Russian |
| 42 | Iberian |
| 50 | Variant 1 |
| 51 | Variant 2 |
| 52 | Variant 3 |
| 53 | Variant 4 |
| 54 | Variant 5 |
| 55 | Variant 6 |
| 56 | Variant 7 |
| 57 | Variant 8 |
| 58 | Variant 9 |
| 59 | Variant 10 |
| 60 | Variant 11 |
| 61 | Variant 12 |
| 62 | Variant 13 |
| 63 | Variant 14 |
| 64 | Variant 15 |
| 65 | Variant 16 |
| 66 | Variant 17 |
| 67 | Variant 18 |

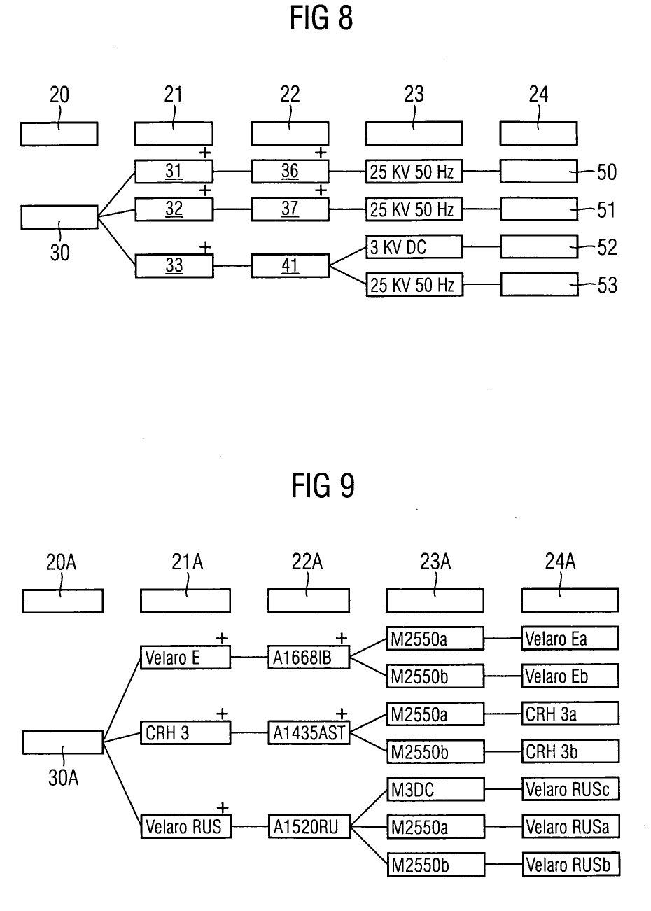

For example, the three countries Spain, Switzerland and Russia each show two unwanted requirements for the rail gauge, and Spain and Switzerland show one unwanted electrification system. Of the 18 variants shown in FIG. 7, all variants, which will not be constructed can be removed from the requirements tree, which results in a requirements tree with 4 variants, as shown in FIG. 8.

According to another aspect of the proposal a solution tree is modeled. This solution tree, as shown in FIG. 9 fulfills the requirements, as demonstrated in the requirements trees, as demonstrated in FIG. 8. The solution tree describes a solution model 30A, which is described in the first column 20A. The second column 21A names the product “Velaro”, the third column 22A holds the axles, the fourth column 23A holds the motors and the fifth column 24A holds variants of the product.

In the present embodiment seven variants of the product “train” can be constructed, all fulfilling the set requirements. As shown, a solution tree may comprise more or less variants than the requirements tree.

According to another aspect of the proposal the solution tree can be transformed into a table. An example for a table holding the requirements is given in the following:

| Velaro | Motor | Name |
|---|---|---|
| Velaro E | M2550a | Velaro Ea |
| Velaro E | M2550b | Velaro Eb |
| CRH 3 | M2550a | CRH 3a |
| CRH 3 | M2550b | CRH 3b |
| Velaro RUS | M3DC | Velaro RUSc |
| Velaro RUS | M2550a | Velaro RUSa |
| Velaro RUS | M2550b | Velaro RUSb |

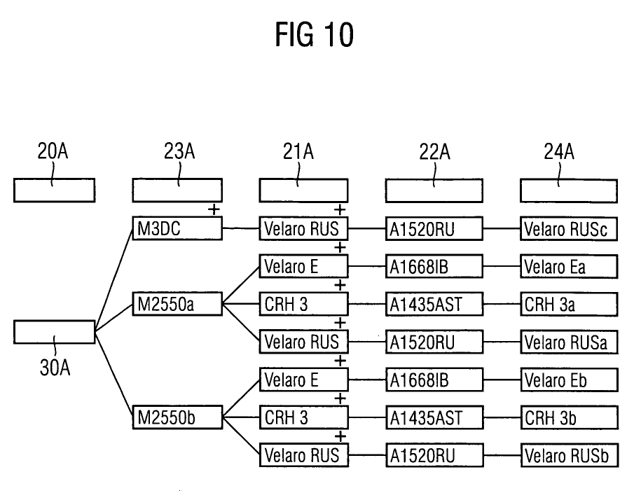

According to another aspect of the proposal the columns may be resorted, which triggers a resorting of the rows. A resorted solution tree is shown in FIG. 10. The solution tree demonstrated in FIG. 10 comprises the same columns as the solution tree, as demonstrated in FIG. 9. In the solution tree as shown in FIG. 10 both columns and rows are resorted.

According to another aspect of the proposal, the solution tree can be transformed into a different representation. In the following a solution model, which is derived from a solution tree as indicated in FIG. 10 is shown:

| Motor | Velaro | Axle | Name |
|---|---|---|---|
| M3DC | Velaro RUS | A1520RU | Velaro RUSc |
| M2550a | Velaro E | A1668IB | Velaro Ea |
| M2550a | CRH 3 | A1435AST | CRH 3a |
| M2550a | Velaro RUS | A1520RU | Velaro RUSa |
| M2550b | Velaro E | A1668IB | Velaro Eb |
| M2550b | CRH 3 | A1435AST | CRH 3b |
| M2550b | Velaro RUS | A1520RU | Velaro RUSb |

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

What is claimed is:

1. A method for identifying variable and common module variants in a product family, the method comprising:
decomposing a product into systems and specifying the system functionality for each system;
subdividing each system functionality into module functionalities;
identifying at least one module variant for each module functionality, said module variant providing the module functionality;
calculating parameters for the module variants to thereby manage the module variants; and
arranging the module variants in the system according to the parameters.

2. The method according to claim 1, wherein the module variants are described by parameters comprising a parameter identifying how many different module variants exist, a selection parameter describing a selection criterion for module variants, and an arrangement parameter describing how the module variants are to be arranged with respect to one another.

3. The method according to claim 2, wherein the arrangement parameter defines positioning of a first module variant as a function of a position of a second module variant.

4. The method according to claim 1, wherein the arrangement parameter defines positioning of a first module variant as a function of a position of a second module variant which abuts the first module variant.

5. The method according to claim 2, wherein the arrangement parameters are provided by a Computer Aided Design program.

6. The method according to claim 1, wherein specifying the system functionality comprises providing a requirements tree, which describes at least one combination of requirements with regard to the system functionality.

7. The method according to claim 6, wherein specifying the system functionality comprises providing a solution tree, which describes at least one combination of module variants that can achieve a desired system functionality.

8. The method according to claim 7, wherein providing the solution tree is accomplished by comparing module variants with the requirements tree.

9. The method according to claim 8, wherein
the solution tree has a plurality of paths,
each path describes a combination of module variants, and
the module variants of each combination achieve the system functionality by co-operation with one another.

10. The method according to claim 9, wherein
the path having fewest module variants and achieving the system functionality is selected, and
the module variants are arranged according to the selected path.

11. A method for identifying module variants in a product, the method comprising:
decomposing the product into systems;
specifying a system functionality for each system, the system functionality being achieved by a co-operation of a plurality of module variants;
subdividing each system functionality into module functionalities; and
identifying at least one module variant for achieving each module functionality.

12. The method according to claim 11, wherein the module variants are managed by calculating parameters for the module variants.

13. The method according to claim 12, wherein
the parameters comprise arrangement parameters each defining a position of a first module variant as a function of a position of a second module variant, and
the module variants are arranged to form the system according to the arrangement parameters.

14. A method for identifying a dependency between a system and a module variant, the method comprising:
specifying the system functionality for the system;
subdividing the system functionality into a plurality of module functionalities;
identifying at least one module variant for achieving each module functionality; and
selecting and arranging the module variants to form the system.

15. The method according to claim 1, wherein
different product variants in a product family are produced by assembling different combinations of module variants, and
the method further comprises:
generating a bill of materials for each product variant; and
for each bill of materials, calculating parameters for each material listed on the bill.

16. The method according to claim 15, wherein different product variants are simulated by iteratively subdividing the system functionality, identifying at least one module variant, arranging the module variants, generating the bill of materials and calculating parameters.

17. An apparatus for identification of variable and common module variants in a product family, the apparatus comprising:
a functionality specification unit to decompose the product family into systems and specify a system functionality for each system;
a system functionality subdividing unit to subdivide each system functionality into a plurality of module functionalities;
a module variant identification unit to identify at least one module variant for each module functionality, said module variant providing the module functionality;
a variant management unit to manage the module variants by calculating at least one parameter for each module variant; and
a module variant arrangement unit to select and arrange the module variants according to the parameters, to thereby form the systems.

18. The apparatus according to claim 17, wherein the functionality specification unit, the system functionality subdividing unit, the module variant identification unit, the variant management unit and the module variant arrangement unit are formed by a calculation unit.

19. A computer readable storage medium storing a program to control a computer to perform a method for identifying variable and common module variants in a product family, the method comprising:
decomposing a product into systems and specifying the system functionality for each system;
subdividing each system functionality into module functionalities;
identifying at least one module variant for each module functionality, said module variant providing the module functionality;
calculating parameters for the module variants to thereby manage the module variants; and
arranging the module variants in the system according to the parameters.
